(19) United States
(12) Patent Application Publication
(10) Pub. No.: US 2022/0158488 A1
(43) Pub. Date: May 19, 2022

(54) WIRELESS POWER TRANSMISSION DEVICE HOLDER AND METHOD FOR MAKING THE SAME

(71) Applicant: TC1 LLC, St. Paul, MN (US)

(72) Inventor: Kevin Francis Bourque, Reading, MA (US)

(21) Appl. No.: 17/527,439

(22) Filed: Nov. 16, 2021

Related U.S. Application Data
(60) Provisional application No. 63/114,353, filed on Nov. 16, 2020.

(51) Int. Cl. H02J 50/00; H02J 50/10; H01F 41/04; A41D 1/00

(52) U.S. Cl. CPC H02J 50/005; A41D 1/002; H01F 41/04; H02J 50/10

(57) ABSTRACT

Described herein is a wireless power transmission device holder for carrying an external coil including a coil body and a wire. The holder includes a fabric panel including a plurality of segments and at least partially defining a cavity sized to receive the coil body. The holder includes a fastening mechanism provided on at least one segment of the plurality of segments on a back side of the fabric panel, wherein the fastening mechanism is configured to engage a garment at a user selected position on the garment, and define an opening sized to receive the wire extending from the coil body.

### CROSS REFERENCE TO RELATED APPLICATIONS

This application claims priority to U.S. Provisional Patent Application No. 63/114,353 filed on Nov. 16, 2020 titled Wireless Power Transmission Device Holder and Method for Making the Same, the entire contents of which are hereby incorporated herein by reference.

### BACKGROUND OF THE DISCLOSURE

### A. Field of Disclosure

The present disclosure relates generally to medical device holders for carrying an external power source on the human body for wireless energy transfer to an implanted medical device inside the body. In particular, the present disclosure relates to medical device holders configured to carry an external transmitter coil on the body of a patient.

### B. Background

At least some known medical devices require a customized garment as an accessory to carry the device in part or whole. One such example is the field of implantable medical devices. Implantable medical devices typically require a power source able to supply adequate power percutaneously or transcutaneously for the reasonable lifetime of the device. When used chronically in some medical devices, a percutaneous power cable presents morbidity risk and reduced quality of life, prompting development of transcutaneous systems. A wireless power transfer system referred to as a transcutaneous energy transfer system (TETS) generally accomplishes energy transfer using two electromagnetically coupled coils arranged like a transformer. Power is transferred electromagnetically across the skin from an external transmitter coil to an implanted receiver coil.

Conventional TETS systems are relatively sensitive to variations in position and alignment of the coupled coils. In order to provide constant and adequate power, the two coils need to be physically close together and well aligned. Further, the preferential location at which the receiver coil is implanted may vary for each patient, and in some situations, may be potentially uncertain until after the receiver coil is surgically implanted. For example, although a sub-clavicular location may typically be used for pacemakers, an abdominal location may instead be preferred by or necessary for some patients. Accordingly, positioning the external transmitter coil relative to the implanted receiver coil is a critical factor that, to some extent, is determined by the accessory worn by the patient to carry the transmitter coil. Thus, a “one size for all” type of accessory, such as a shirt or gown with a feature designed to generically hold an external transmitter coil, may not be suitable for all patients with respect to accurately positioning the external transmitter coil.

Besides criticality of relative coil placement, there are numerous other disadvantages to a medical device manufacturer of providing a garment with an integrated coil holder for patients, such as, for example, maintaining multiple sizes and maintaining both male and female styles, thereby increasing inventory and cost; facilitating variations in patient fashion and style preferences and putting additional pressure on inventory; and accommodating changes in patient body habits and behavior, e.g., weight gain or loss. Moreover, the need for multiple garments (e.g., to allow washing or for replacing damaged garments) also creates unusual consumer relationships: the garment is critical in fitting properly to the patient, enabling activities of daily life, and enhancing quality of life; whereas the integrated coil holder is focused upon coil alignment.

### SUMMARY OF THE DISCLOSURE

The disclosed apparatus separates the holder from the garment such that the medical device manufacturer supplies only the holder that may be readily attached to a patient's garment of choice, averting the disadvantages of a holder integrated with a full garment.

In one embodiment, a wireless power transmission device holder for carrying an external coil is provided. The external coil includes a coil body and a wire. The holder includes a fabric panel including a plurality of segments and at least partially defining a cavity sized to receive the coil body. The holder includes a fastening mechanism provided on at least one segment of the plurality of segments on a back side of the fabric panel, wherein the fastening mechanism is configured to engage a garment at a user selected position on the garment, and define an opening sized to receive the wire extending from the coil body.

In another embodiment, a method of manufacturing a wireless power transmission device holder for carrying an external coil is provided. The external coil includes a coil body and a wire. The method includes providing a fabric panel comprising a plurality of segments and at least partially defining a cavity sized to receive the coil body. The method includes applying a fastening mechanism on at least one segment of the plurality of segments on a back side of the fabric panel. The method includes attaching the fabric panel to a garment at a user selected position on the garment by engaging the fastening mechanism on the at least one segment with the garment to form an opening sized to receive the wire extending from the coil body.

In a further embodiment, a wireless power transmission device holder system including an external coil and a wireless power transmission device holder is provided. The external coil includes a coil body and a wire extending from the coil body. The wireless power transmission device holder a fabric panel comprising a plurality of segments and at least partially defining a cavity sized to receive the coil body. The holder includes a fastening mechanism provided on at least one segment of the plurality of segments on a back side of the fabric panel, wherein the fastening mechanism is configured to engage a garment at a user selected position on the garment, and define an opening sized to receive the wire extending from the coil body.

### BRIEF DESCRIPTION OF THE DRAWINGS

FIG. 1 illustrates a patient placing an external coil in a wireless power transmission device holder to wirelessly transmit power to an implanted coil;

FIG. 2 illustrates a front perspective view of one embodiment of the wireless power transmission device holder shown in FIG. 1;

FIG. 3 illustrates one example embodiment of a fastening mechanism for the wireless power transmission device holder shown in FIG. 2;

FIG. 4 illustrates another example embodiment of a fastening mechanism for the wireless power transmission device holder shown in FIG. 2;

FIG. 5 illustrates another example embodiment of a fastening mechanism for the wireless power transmission device holder shown in FIG. 2;

FIG. 6 illustrates a front perspective view of another example embodiment of the wireless power transmission device holder shown in FIG. 1;

FIG. 7 illustrates a front perspective view of another example embodiment of the wireless power transmission device holder shown in FIG. 1;

FIG. 8 illustrates various user selected positions in which the wireless power transmission device holder shown in FIG. 1 may be attached to garments worn by a patient; and

FIGS. 9-11 illustrate various embodiments of an example plastic insert that may be used with the wireless power transmission device holders shown in FIGS. 1-8.

Corresponding reference characters indicate corresponding parts throughout the several views of the drawings. It is understood that that Figures are not necessarily to scale.

### DETAILED DESCRIPTION OF THE DISCLOSURE

The present disclosure relates generally to a medical device holder suitable for carrying an external component of a medical device on the body of a patient. In particular, the holder is suitable for positioning and holding a wireless power transmission device, such as an external transmitter coil, in proximity to an implanted receiver coil for optimal wireless energy transmission. The holder is configured to secure the external transmitter coil to a garment of the patient in a user selected position. The patient's garment may include, for example, a shirt, dress, vest, bra or sports bra or other undergarment, pants, or skirt, among others.

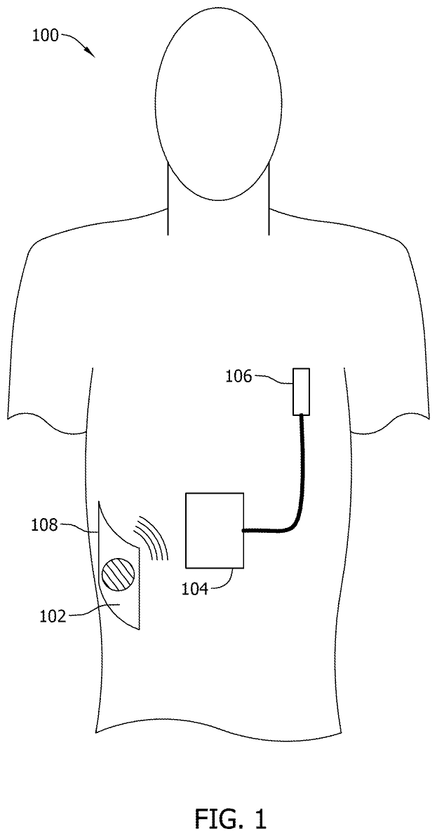

Referring now to the drawings, FIG. 1 illustrates one embodiment of a patient 100 using an external transmitter coil 102 (a wireless power transmission device) to wirelessly transmit power to an implanted coil 104. Implanted coil 104 uses the received power to power an implanted device 106. For example, implanted device 106 may include a pacemaker or heart pump. As shown in FIG. 1, external transmitter coil 102 is attached (e.g., simply via press-on or a house-hold iron) to the patient's garment using a wireless power transmission device holder 108 at a user selected position. The user selected position may be determined by a physician or a patient based on the location of the implanted coil 104 in the patient's body.

In one embodiment, external coil 102 is communicatively coupled to a computing device (not shown), for example, via wired or wireless connection, such that external coil 102 may receive signals from and transmit signals to the computing device. In some embodiments, the computing device is a power source for external coil 102. In other embodiments, external coil 102 is coupled to an alternative power supply (not shown). In some embodiments, the computing device further includes a user interface (UI) (not shown) to present information to a user (e.g., patient 100). For example, the UI may display one or more representations designed to aid patient 100 in positioning wireless power transmission device holder 108 on a garment such that external coil 102 and implanted, or receiver, coil 104 are well aligned for optimal energy transmission.

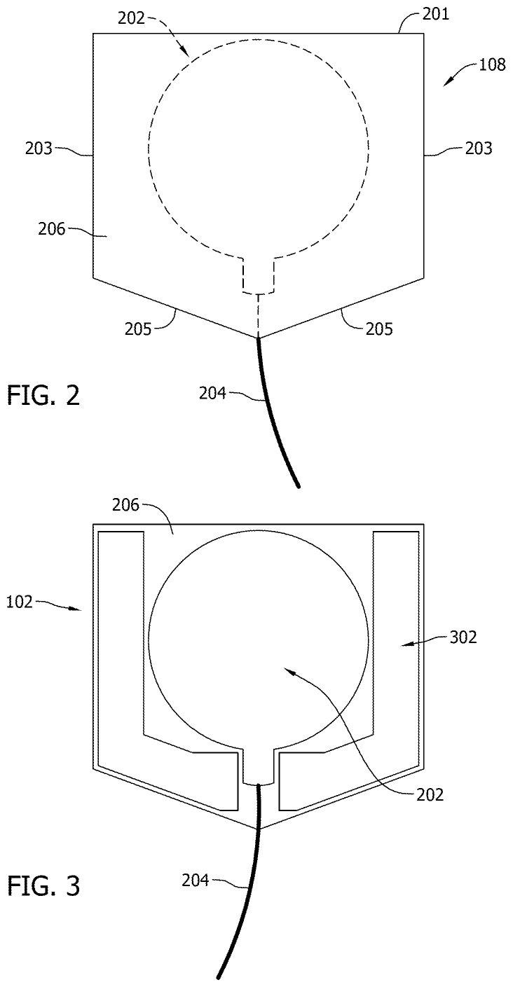

FIG. 2 is a front perspective view of one embodiment of wireless power transmission device holder 108. Holder 108 includes a top edge 201, a pair of side edges 203, and a pair of bottom edges 205. FIGS. 3-5 illustrate various embodiments of making the wireless power transmission device holder 108 shown in FIG. 2. As shown in FIGS. 2-5, external coil 102 includes a coil body 202 and a wire (cable) 204 extending from coil body 202. One end of wire 204 connects to coil body 202 and the other end of wire 204 connects to a power source.

Wireless power transmission device holder 108 is generally sized to cover coil body 202 and a portion of wire 204. In some embodiments, holder 108 is generally sized to cover only coil body 202. The size of holder 108 may vary based upon the size of external coil 102 and/or the non-stitch means used to attach holder 108 to a garment (as described below). External coil 102, in certain embodiments, may be about 0.5 inches thick, circular or at least partially rounded, and having a diameter of about 3.0 inches. Alternatively, thickness of external coil 102 may be less than 0.5 inches, e.g., in the range of about 0.1 inches to 0.5 inches, or greater than 0.5 inches. Likewise, external coil 102 may assume a different profile (i.e., non-circular or non-rounded) and have a various other dimensions suitable for a sufficient power transfer to implanted coil 104. Holder 108 may be formed from any suitable clothing material, such as, for example, canvas, polyester, cotton, or others.

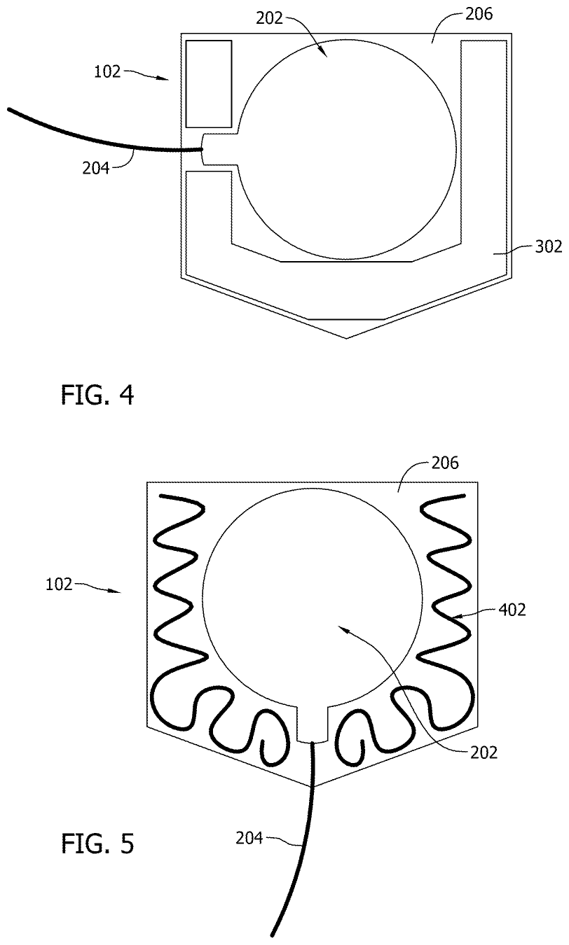

As shown in FIGS. 2-5, wireless power transmission device holder 108 includes a panel 206 and a fastening mechanism, such as, for example, an adhesive or other bonding agent. In one embodiment, panel 206 is a fabric material and the fastening mechanism is a fabric adhesive applied to one or more segments of panel 206. In FIGS. 3 and 4, the fastening mechanism is a fabric tape (e.g., fabric fusing tape) 302 utilized to attach panel 206 to a garment in a user selected position on the garment. In FIG. 5, the fastening mechanism is a fabric glue (e.g., fabric fusing glue) 402 utilized to attach panel 206 to a garment at the user selected position to form holder 108. In some embodiments, panel 206 is a woven material, such as, for example, linen, denim, cotton, and/or canvas. In other embodiments, panel 206 is a non-woven material, such as, for example, felt.

Holder 108 is formed by attaching panel 206 to a garment using a fastening mechanism. The fastening mechanism is a non-stitch means (e.g., a bonding agent), thereby enabling patient 100 to readily and easily select a position and place external coil 102 within the formed holder 108 for wireless energy transmission. With respect to panel 206, FIG. 2 illustrates a front perspective view of panel 206, and FIGS. 3-5 illustrate a back perspective view of panel 206.

As shown in FIGS. 3-5, the wireless power transmission device holder 108 shown in FIG. 2 is formed by providing the fastening mechanism on one or more segments of panel 206. For example, holder 108 is formed by outlining the back edges of panel 206 with a fabric adhesive. Panel 206 is shaped to accommodate external coil 102 and a bonding agent. Although panel 206 includes five corners, panel 206 may include any suitable number of corners and edges to securely position external coil 102. Further, although FIGS. 2 and 3 provide an opening for wire 204 at one of the corners, the wire opening can be provided at any of the edge portions of panel 206, as illustrated in FIG. 4.

In one embodiment, panel 206 is preloaded with a fastening mechanism. In one example, back edge portions of panel 206 include a layer of fabric tape covered in a layer of protective film. In this example, patient 100 removes the protective film to securely attach panel 206 to a garment. The protective film may include a pull tab. In other embodiments, patient 100 directly applies the fastening mechanism to panel 206 to form holder 108. In one example, patient 100 applies fabric glue 402 to back edge portions to securely attach panel 206 to a garment.

As shown in FIGS. 3 and 4, patient 100 can position holder 108 in various arrangements such that wire 204 extends vertically or horizontally from holder 108 by choosing which back edge portions of panel 206 to apply the fabric adhesive to. Fabric adhesive is not applied to the back edge portions designated for insertion and/or removal of coil body 202 and wire 204. Wireless power transmission device holder 108 may be removably or non-removably attached to the patient's garment based upon the non-stitch means used by patient 100.

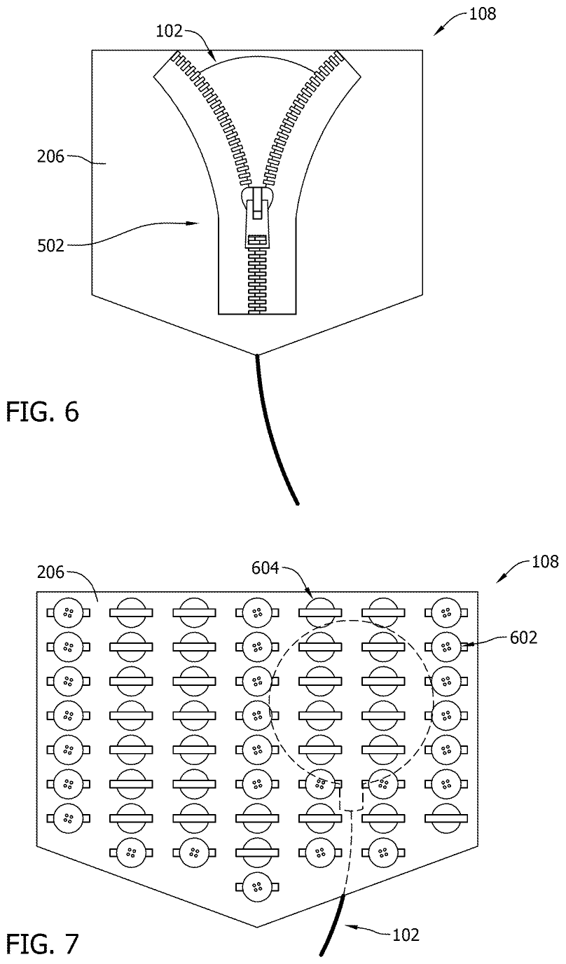

FIG. 6 illustrates a front perspective view of another embodiment of wireless power transmission device holder 108. In FIG. 6, holder 108 provides enhanced usability by implementing a zipper feature, Velcro, or other feature that enables easy repeatable access and closure. A zipper 502, for example, is fastened to panel 206 to enable panel 206 to separate into two portions for insertion and/or removal of external coil 102. Zipper 502 can be vertically affixed to panel 206 to detachably couple two vertical portions. Alternatively, zipper 502 can be horizontally affixed to panel 206 to detachably couple two horizontal portions of panel 206. A fabric adhesive, such as fabric tape 302 (shown in FIG. 3) and fabric glue 402 (shown in FIG. 5) may be applied to back edge portions of panel 206 to securely attach panel 206 to a garment of patient 100.

FIG. 7 illustrates a front perspective view of another embodiment of wireless power transmission device holder 108. In FIG. 7, holder 108 includes buttons 602 and two panels 206. One panel 206 includes rows and columns of buttons 602. The other panel 206 includes button holes (e.g., slots) 604 that correspond to buttons 602. Patient 100 may fasten the panel 206 including buttons 602 to a garment. Fastening panel 206 enables coarse alignment with implanted coil 104. As shown in FIG. 7, holder 108 creates an oversized pocket (cavity) that accommodates the length of two external coils 102. The oversized pocket provides patient 100 with multiple positioning options by allowing external coil 102 to be shifted from one position to another within the cavity. For example, patient 100 can easily secure external coil 102 near the upper left, lower left, upper right, lower right, or middle location of holder 108 by selecting which buttons 602 to slide through button holes 604. Buttons 602 and button holes 604, for example, enable a finer, or more precise, alignment of external coil 102 with implanted coil 104.

Buttons 602 may be no-sew buttons, such as, for example, tack buttons and/or snap buttons. One or more fasteners, including snaps and/or Velcro may be used to attach one or more panels 206 to a garment to form various embodiments of wireless power transmission device holder 108, as described herein. In other embodiments, panel 206 is a heat transfer vinyl (HTV) material, such as, for example, a polyurethane (PU) or poly vinyl chloride (PVC) material that can be ironed onto a patient's garment.

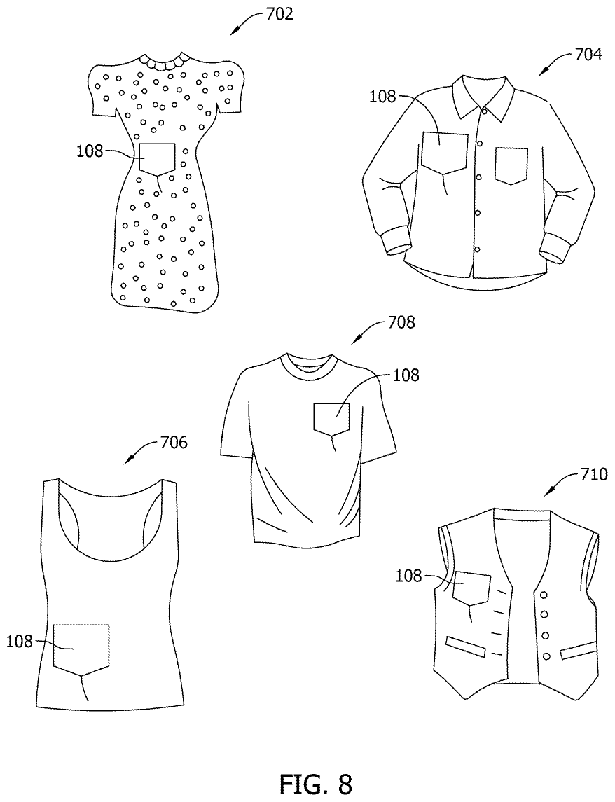

FIG. 8 illustrates various positions of wireless power transmission device holder 108 on a variety of garments that may be worn by patient 100. Holders 108 can be formed on multiple types of garments (i.e., cotton, linen) and on different positions of the garments, as shown by garments 702-710, to readily accommodate external coil 102 in various settings (i.e., formal, casual, home, work, vacation, travel) and seasons. For example, garments 702 and 706 show holder 108 positioned along the abdominal region. Garments 704, 708, and 710 show holder 108 positioned on the upper right chest region and on the upper left chest region. Although garments 702-710 show holder 108 formed on the garment exterior, holder 108 can be formed on the garment interior by attaching panel 206 to the inside of a patient's garment.

In some embodiments, holder 108 is removable. In these embodiments, panel 206 is removably attached to the patient's garment. In other embodiments, panel 206 is permanently attached to the patient's garment to form holder 108. In one example, fabric glue 402 is utilized to permanently attach panel 206 to a garment. In another example, fabric tape 302, tack buttons, and/or snap buttons are utilized to removably attach panel 206 to a garment.

In some embodiments, static electric charge (static electricity, static cling) is used to fix holder 108 to a garment. A relative charge may be formed between panel 206 and the garment, such as garments 702-710, for example, by rubbing together to create static attraction. Panel 206 is a non-woven synthetic material that holds static electric charge, such as polyester, nylon, and/or plastics. In these embodiments, the static electric charge produces a sufficient attachment to support the weight of external coil 102. After wireless power transmission is complete, holder 108 is removed from the garment by peeling panel 206 away from the garment.

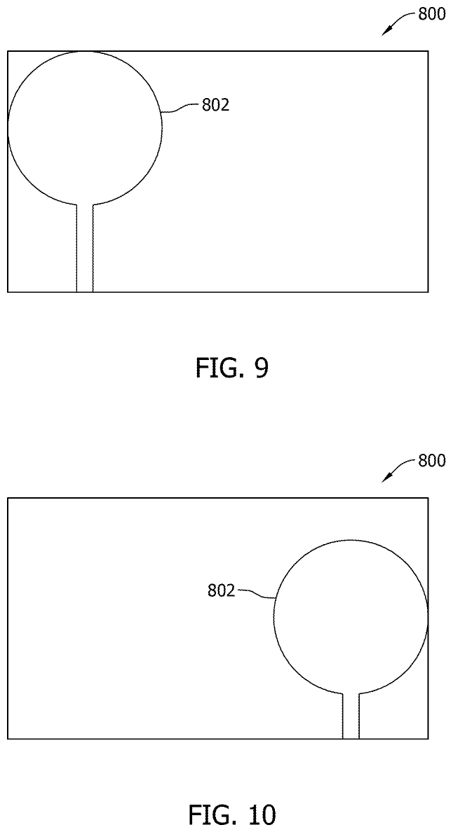

FIGS. 9-11 illustrate various embodiments of a plastic insert 800 for optimally and securely positioning external coil 102 within the cavity (not shown) formed by wireless power transmission device holder 108. Holder 108 is sized to cover plastic insert 800. Holder 108 is formed by attaching one or more panels 206 to a patient's garment, as described above. In one embodiment, plastic insert 800 is the size of a playing card or a credit card. Plastic insert 800 is sized to establish a close-fit arrangement within the cavity to substantially eliminate any gaps (spacing) between side edges 203 and plastic insert 800.

The close-fit arrangement secures the positioning of external coil 102 by preventing plastic insert 800 from shifting within the cavity. Each plastic insert 800 includes snap fit protuberances 802 for securely coupling coil body 202 and wire 204 to plastic insert 800. As shown in FIGS. 9-12, snap fit protuberances 802 are sized and shaped to receive both coil body 202 and wire 204 to secure the position of external coil 102 during wireless energy transmission. Protuberances extend outwardly from a surface of plastic insert 800 to facilitate locking coil body 202 and wire 204 in place.

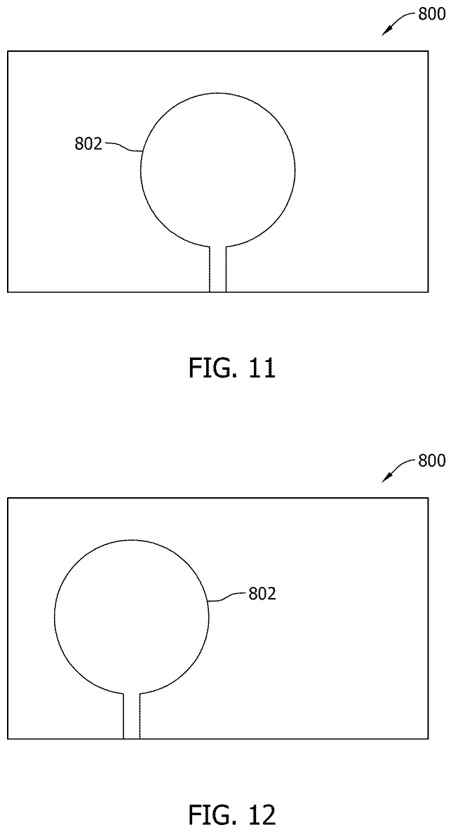

Each plastic insert 800 provides a specific location for positioning external coil 102 for wireless energy transmission. In FIG. 9, snap fit protuberances 802 for coil body 202 are provided in a corner location of plastic insert 800. In FIG. 10, snap fit protuberances 802 for coil body 202 are provided in a side location of plastic insert 800. In FIG. 11, snap fit protuberances 802 for coil body 202 are provided in a center location of plastic insert 800. In FIG. 12, snap fit protuberances 802 for coil body 202 are provided in an off-center location of plastic insert 800. Although FIGS. 11-14 show snap fit protuberances 802 in four locations, snap fit protuberances 802 may be provided in any suitable location on plastic insert 800 to align external coil 102 and implanted coil 104 for optimal wireless energy transmission. In some embodiments, instead of snap fit protuberances 802, other suitable means may be utilized to lock external coil 102 in place, such as any of the fastening mechanisms, fasteners, or bonding agents described herein.

In one embodiment, after a medical device is implanted inside the body, patient 100 receives a discharge kit. The kit includes a set of plastic inserts 800 and a number of panels 206, such as, for example, five to ten panels 206. Additionally or alternatively, the kit may include panels 206 of varying sizes, shapes, materials, and/or colors as well as fastening mechanisms such as fasteners or bonding agents. Any of the different types of panels 206 and fastening mechanisms described herein may be provided in the kit. The kit includes instructions for making wireless power transmission device holder 108. In certain embodiments, the kit also includes instructions identifying suitable location(s) for positioning panel(s) 206 on a garment(s) of choice (e.g., a dress, vest, bra, pants, skirt, shirt) for optimal coil alignment.

While embodiments of the present disclosure have been described, it should be understood that various changes, adaptations and modifications may be made therein without departing from the spirit of the disclosure and the scope of the appended claims. Further, all directional references (e.g., upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of the disclosure. It is intended that all matter contained in the above description or shown in the accompanying drawings shall be interpreted as illustrative only and not limiting. Changes in detail or structure may be made without departing from the spirit of the disclosure as defined in the appended claims.

Many modifications and other embodiments of the disclosure set forth herein will come to mind to one skilled in the art to which this disclosure pertains having the benefit of the teachings presented in the foregoing descriptions and the associated drawings. Therefore, it is to be understood that the disclosure is not to be limited to the specific embodiments described and that modifications and other embodiments are intended to be included within the scope of the appended claims. Although specific terms are employed herein, they are used in a generic and descriptive sense only and not for purposes of limitation.

Any patent, publication, or other disclosure material, in whole or in part, that is said to be incorporated by reference herein is incorporated herein only to the extent that the incorporated materials does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

What is claimed is:

1. A wireless power transmission device holder for carrying an external coil including a coil body and a wire, the wireless power transmission device holder comprising:
a fabric panel comprising a plurality of segments and at least partially defining a cavity sized to receive the coil body; and
a fastening mechanism provided on at least one segment of the plurality of segments on a back side of the fabric panel, wherein the fastening mechanism is configured to engage a garment at a user selected position on the garment, and define an opening sized to receive the wire extending from the coil body.

2. The wireless power transmission device holder of claim 1, wherein the cavity is sized to establish a close-fit arrangement with the coil body.

3. The wireless power transmission device holder of claim 1, wherein the fastening mechanism is a layer of fabric tape covered in a layer of protective film.

4. The wireless power transmission device holder of claim 1, wherein the fastening mechanism is at least one of fabric fusing glue, velcro, and snaps.

5. The wireless power transmission device holder of claim 1, further comprising a plastic insert including snap fit protuberances for coupling the external coil to the plastic insert.

6. The wireless power transmission device holder of claim 5, wherein the snap fit protuberances extend outwardly from a surface of the plastic insert, and wherein the snap fit protuberances are shaped to receive the coil body and the wire.

7. The wireless power transmission device holder of claim 5, wherein the plastic insert is sized to establish a close-fit arrangement within the cavity to substantially eliminate gaps between an edge and the plastic insert.

8. The wireless power transmission device holder of claim 1, wherein the fabric panel is a non-woven synthetic material configured to hold a static electric charge.

9. The wireless power transmission device holder of claim 1, further comprising a zipper, and wherein the fabric panel comprises two portions that are detachably coupled to one another at the zipper.

10. A method of manufacturing a wireless power transmission device holder for carrying an external coil including a coil body and a wire, the method comprising:
providing a fabric panel comprising a plurality of segments and at least partially defining a cavity sized to receive the coil body;
applying a fastening mechanism on at least one segment of the plurality of segments on a back side of the fabric panel; and
attaching the fabric panel to a garment at a user selected position on the garment by engaging the fastening mechanism on the at least one segment with the garment to form an opening sized to receive the wire extending from the coil body.

11. The method of claim 10, wherein the fastening mechanism is a layer of at least one of fabric tape and fabric fusing glue.

12. The method of claim 10, further comprising providing a zipper extending from a top edge of the fabric panel, and wherein the fabric panel comprises two portions that are detachably coupled to one another at the zipper.

13. The method of claim 10, further comprising providing a plastic insert including snap fit protuberances for coupling the external coil to the plastic insert.

14. The method of claim 13, wherein the snap fit protuberances extend outwardly from a surface of the plastic insert, and wherein the snap fit protuberances are shaped to receive the coil body and the wire.

15. The method of claim 13, wherein the plastic insert is sized to establish a close-fit arrangement within the cavity to substantially eliminate gaps between an edge and the plastic insert.

16. A wireless power transmission device holder system comprising:
an external coil including a coil body and a wire extending from the coil body; and
a wireless power transmission device holder comprising:
a fabric panel comprising a plurality of segments and at least partially defining a cavity sized to receive the coil body; and
a fastening mechanism provided on at least one segment of the plurality of segments on a back side of the fabric panel, wherein the fastening mechanism is configured to engage a garment at a user selected position on the garment, and define an opening sized to receive the wire extending from the coil body.

17. The wireless power transmission device holder system of claim 16, wherein the fastening mechanism is a layer of fabric tape covered in a layer of protective film.

18. The wireless power transmission device holder system of claim 16, wherein the wireless power transmission device holder further comprises a plastic insert including snap fit protuberances for coupling the external coil to the plastic insert.

19. The wireless power transmission device holder system of claim 18, wherein the snap fit protuberances extend outwardly from a surface of the plastic insert, and wherein the snap fit protuberances are shaped to receive the coil body and the wire.

20. The wireless power transmission device holder system of claim 18, wherein the plastic insert is sized to establish a close-fit arrangement within the cavity to substantially eliminate gaps between an edge and the plastic insert.
